(19) United States
(12) Patent Application Publication
(10) Pub. No.: US 2014/0074649 A1
(43) Pub. Date: Mar. 13, 2014

(54) GROCERY RECOMMENDATION ENGINE

(71) Applicants: Kavel Patel, Santa Clara, CA (US); Sajjit Thampy, Sunnyvale, CA (US)

(72) Inventors: Kavel Patel, Santa Clara, CA (US); Sajjit Thampy, Sunnyvale, CA (US)

(73) Assignee: Coupons.com Incorporated, Mountain View, CA (US)

(21) Appl. No.: 13/612,848

(22) Filed: Sep. 13, 2012

(51) Int. Cl. G06Q 30/00

(52) U.S. Cl. 705/26.7

(57) ABSTRACT

State-based approaches, techniques, and mechanisms are disclosed for recommending items to a user. A method comprises detecting a user state, from a plurality of different enumerated user states, based on items that the user recently selected, and/or location data. Based upon the detected user state, a particular algorithm, from a plurality of algorithms, is selected for recommending items. Information about the recommended items is presented to the user. Responsive to presenting the information about the recommended items, input is received selecting one or more of the recommended items for at least one of: adding to a shopping list, or requesting a coupon. Examples of possible detected user states include a recipe state, a grocery shopping state, and a quick shopping-run state. In an embodiment, state detection occurs at a client device, such as a smartphone featuring a shopping list management application or coupon application. A server-side recommendation engine provides recommendations.

### TECHNICAL FIELD

Embodiments relate generally to coupon distribution, and, more specifically, to techniques for selecting shopping items of interest to a user.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

A number of web-based and mobile computer program applications integrate coupon distribution with shopping assistance features. Examples of such applications are described in, for example, U.S. Patent Publication Number 2012/0084122 A1, titled “COUPON INTEGRATION WITH SHOPPING LISTS,” filed by Jason Boehle on Oct. 1, 2010, the contents of which are hereby incorporated by reference for all purposes as if fully set forth herein. A specific example of such an application is the mobile application known as GroceryIQ, provided by Coupons.com Incorporated, which, among other features, allows users to both create grocery lists and “clip” digital versions of grocery-related coupons in a common user interface.

Because of the popularity of applications that integrate shopping lists with coupon distribution, coupon providers increasingly make coupons available for distribution using such applications. The increasing number of available coupon offers can make it difficult for a user to quickly find coupon offers of interest to the user, and consequently decrease the likelihood that the user will utilize the application at all. Some simple solutions to this problem are to provide a user with an interface to search for coupons of interest, or to only show to the user coupons that are associated with items in a shopping list. There are, however, a number of well-known disadvantages to such solutions. For example, users are often uncertain of or forget which items they actually need to purchase.

More complicated solutions involve identifying items that may be of interest to user and recommending those items to a user. For example, many online retailers provide personalized recommendations of items that may be of interest to a user, based on prior interactions with that user. These retailers commonly use market-basket algorithms such as FP-Tree or Apriori-Algorithm to identify items to recommend to the user based on the user's prior interactions. However, the existing techniques are still problematic. For example, among other problems, many techniques fare poorly when there is even a small skew in the distribution of items that are actually of interest to a user.

### BRIEF DESCRIPTION OF THE DRAWINGS

In the drawings:

FIG. 1 illustrates a flow for selecting items to recommend to a user based on identifying a state of the user;

FIG. 2 illustrates a flow for detecting when a user is in a recipe state and recommending items based on that state;

FIG. 3 illustrates a flow for identifying a chain of items to recommend to a user;

FIG. 4 illustrates a flow for calculating cycle-based probabilities for items and recommending items to a user based thereon;

FIG. 5 illustrates an example system with client-based state identification, in which the techniques described herein may be practiced;

FIG. 6 illustrates another example system, having server-based state identification, in which the techniques described herein may be practiced; and

FIG. 7 illustrates a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:

1.0. General Overview

2.0. Functional Overview
2.1. User State-Based Recommendations
2.2. Detecting a “Recipe” State and Recommending Items Based Thereon
2.3. Identifying a Chain of Recommended Items
2.4. Calculating Cycle-Based Probabilities and Recommending Items Based Thereon

3.0. Structural Overview
3.1. Example System with Client-Based State Identification
3.2. Example System with Server-Based State Identification

4.0. Implementation Examples

5.0. Implementation Mechanism—Hardware Overview

6.0. Extensions and Alternatives

### 1.0. General Overview

State-based approaches, techniques, and mechanisms are disclosed for recommending items to a user. In an embodiment, a method comprises identifying location data currently associated with the user. The method further comprises identifying, from a plurality of items that a user may select, any items that the user has recently selected. The items that the user may select include one or more of: products for purchase, services for purchases, or coupon offers. The method further comprises detecting a user state, from a plurality of different enumerated user states, based at least on one or both of: items that the user recently selected, or the location data. The method further comprises maintaining a plurality of instruction sets, each instruction set implementing a different algorithm of a plurality of algorithms for recommending items from the plurality of items. Based upon the detected user state, the method comprises selecting a particular algorithm, from the plurality of algorithms, for recommending items. The method further comprises executing a particular instruction set, from the plurality of instruction sets, which implements the particular algorithm. Based on executing the particular instruction set, the method further comprises identifying recommended items for the user. The method further comprises causing information about the recommended items to be presented to the user. Responsive to presenting the information about the recommended items, the method further comprises receiving input selecting one or more of the recommended items for at least one of: adding to a shopping list, or requesting a coupon.

In an embodiment, the detected user state is a recipe building or recipe ingredient shopping mode. The particular algorithm corresponding to the recipe mode comprises selecting recommended items that occur in recipe clusters with one or more of the items that the user has recently selected. In an embodiment, detecting the recipe mode is based on, for each item of the items that the user recently selected, a probability that the item is used in a recipe. Each probability for each item is calculated based on input from a plurality of users indicating the likelihood that one or more item sets that include the item were selected for use in a recipe. In an embodiment, the recipe clusters are based on input from a plurality of users indicating the likelihood that one or more item sets that include the item were selected for use in a recipe.

In an embodiment, the detected user state is a grocery-shopping mode. The particular algorithm corresponding to the grocery-shopping mode comprises: based on historical data for an account associated with the client, identifying first recommended items from a first set of items that have been previously selected in association with the account; identifying second recommended items from a second set of items that frequently co-occur, with the items in the first set of items, in item sets selected by other users; merging the first set of recommended items and the second set of recommended items based on probabilities associated with each item in the first set of recommended items and the second set of recommended items. In an embodiment, identifying the second recommended items comprises: analyzing a plurality of collections of items sets for co-occurring items and assigning co-occurrence scores to the co-occurring items based on a co-occurrence frequency within each collection in which the co-occurring items occur. Each of the plurality of collections consists of item sets selected exclusively by different groups of users. An embodiment comprises selecting at least one of the groups of users based on the location data.

In an embodiment, the detected user state is a quick shopping-run mode. The particular algorithm corresponding to the quick shopping-run mode comprises: analyzing a user history for selection patterns indicating windows of time in which the user is expected to select an item; and identifying the recommended items based upon the selection patterns. In an embodiment, a particular selection pattern of the selection patterns comprises a cycle of phases, each phase of the phases having different windows of time occurring at different frequencies relative to each other of the phases. In an embodiment, detecting the quick shopping-run mode comprises detecting that the user added more than a certain number of items to a shopping list within a recent period of time.

In an embodiment, a system for practicing the techniques described herein comprises a database describing a plurality of items that a user may select, the plurality of items including one or more of: products for purchase, services for purchases, or coupon offers. The system further comprises a memory storing a plurality of instruction sets, each instruction set implementing a different algorithm of a plurality of algorithms for recommending items from the plurality of items. The system further comprises one or more computing devices configured to implement a recommendation engine. The recommendation engine is configured for: receiving from a client, over a network, input indicating a user state associated with a user of the client, from a plurality of different enumerated user states; based upon the detected user state, selecting a particular algorithm, from the plurality of algorithms, for recommending items; executing a particular instruction set, from the plurality of instruction sets, that implements the particular algorithm; based on executing the particular instruction set, identifying recommended items for the user; and sending to the client recommendation data describing the recommended items.

In other aspects, the invention encompasses a computer apparatus and a computer-readable medium configured to carry out the foregoing steps.

### 2.0. Functional Overview

This section generally describes several techniques for identifying items to recommend to a user. These may be used individually, or in conjunction with each other. The techniques involve various steps performed by all or some of a shopping list management application, coupon distribution component, and/or an item recommendation engine, each of which may be located on a client, such as a mobile device or personal computer, or a server. More specific example system architectures for practicing these techniques are described in section 3.0.

Various techniques described herein involve identifying “items” to recommend to a user. In some embodiments, the identified items are products or services for purchase or otherwise acquirable by the user, such as canned goods or cleaning supplies. An item may be general in nature, such as “soup,” or specific, such as “16 oz. Brand X Tomato Soup Can.” A user, coupon distributor, or other entity may optionally then search for coupons for the identified items. In other embodiments, the identified items are coupon offers. In yet other embodiments, the identified items may include products and coupon offers. In general, the process of identifying items as described herein refers more specifically to identifying different records or objects within a data repository that describe or otherwise represent these items, such as different database records that are each associated with a unique Universal Product Code (UPC), European Article Number (EAN), stock-keeping unit (SKU), manufacturer model number, coupon offer identifier, or other identifier for a represented item.

Depending on the embodiment, or even a specific recommendation algorithm, a “set of items selected by a user” and like terms may refer to any or all of: items that were purchased together in a transaction, items that the user were placed together in the same shopping list within a certain period of time, items for which the user requested a coupon within a certain period of time, and/or items for which the user actually redeemed coupons over a certain period of time. A “set of items selected by a user” or like terms may also or instead refer to coupon offers for any of the above items. The sets of selected items may be identified from any or all of historical transaction data for a plurality of users, historical shopping list data for a plurality of users, or historical coupon tracking data for a plurality of users.

Identifying items selected by the user may involve, for example, accessing, or directing a shopping list management application to access, a repository of shopping list items added by the user. Each item in the shopping list may be associated with timestamps and/or other metadata that may be used to determine how recently the user added the item to the shopping list. Or all items in the shopping list may simply be considered “recent,” regardless of when added to the shopping list. Identifying the items may also or instead involve reviewing a log of items involved in transactions, in association with timestamps of those transactions. Transaction logs may be accessed, for example, at a server to which retailers upload purchase history information. Transaction logs may also be accessed via, for example, a payment and/or receipt tracking application on a mobile device. A history of items in a shopping list marked by the user as purchased may substitute for a transaction log. Identifying the items may also or instead involve reviewing, or instructing a coupon distribution component to review, time stamped logs of coupon-related activities, such as coupon printing, electronic coupon “clipping,” and/or coupon redemption.

In some embodiments, the identified items are items that have been added to a shopping list or purchased within a certain period of time, such as the last day, the last hour, the period of time that has elapsed since the user last went shopping, or the period of time that has elapsed since the user last launched the shopping list management application.

In some embodiments, the meaning of the term “recent” is relative to the location data that is analyzed in block 110. For example, an item may be considered to have been added to a shopping list recently if the item was added in the time since the user arrived at a currently indicated location and/or within a few minutes prior to the user leaving home or work. Moreover, different techniques of identifying items may apply to items that were added to a shopping list as opposed to items that were recently purchased. For instance, any item that is in a shopping list may be considered “recent,” whereas purchased items may only be considered recent if they were purchased in the last hour.

2.1. User State-Based Recommendations

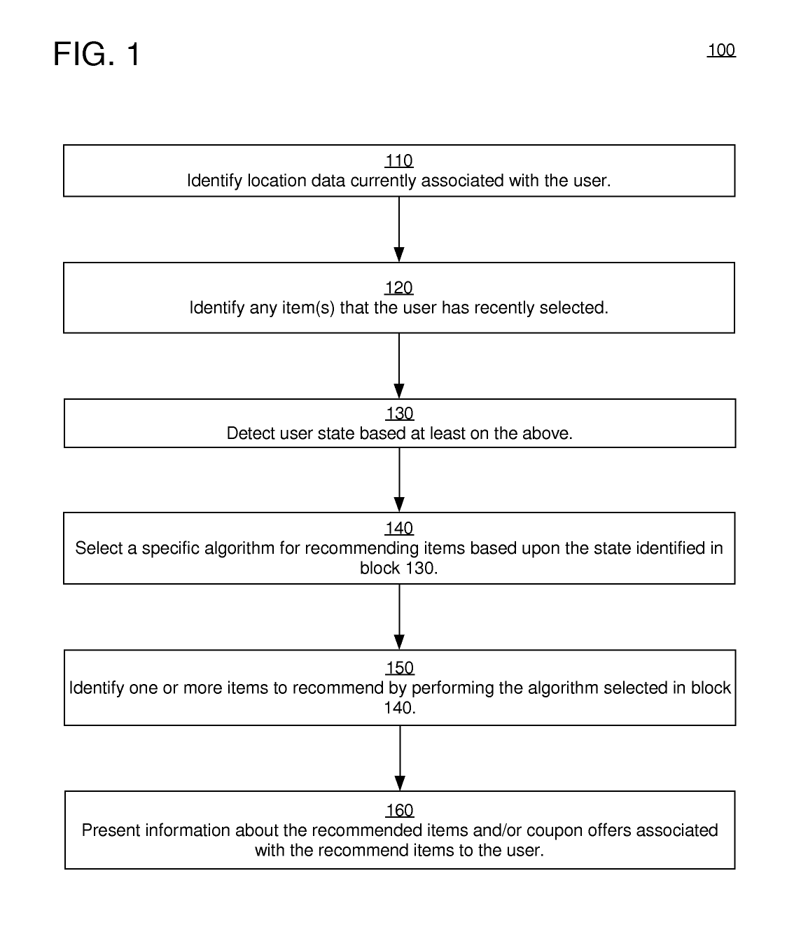

FIG. 1 illustrates a flow 100 for selecting items to recommend to a user based on identifying a state of the user, according to an embodiment.

Block 110, which is optional, comprises identifying location data currently associated with the user. The location data may specify a unique location such as an address, coordinate, or zip code. Or, the location data may specify a characteristic of the location, such as “at a grocery store,” “at store X,” “at home,” or “on the way to work.” In an embodiment, explicit input from the user specifies the location data. For example, the user may launch a shopping management application and then select a tab associated with a particular grocery store. In an embodiment, the location data is derived from data other than explicit user input, such as cell phone sensor data and user tracking data. In an embodiment, the location data reflects a predicted location based on GPS logs or transaction logs collected over a period of time.

The location data need not indicate a location precisely. Rather, various techniques may be utilized to select a “best-guess” location based on the afore-mentioned inputs. For example, a shopping management application may identify a group of more specific candidate locations based on sensor data, such as cell phone towers and signal strength. One or more specific locations or categories of locations may be selected from this group of candidate locations based on any of a variety of factors such as popularity, user history, coupon availability, a comparison of items associated with the user's shopping list to inventories at one or more stores at each specific candidate location, and so forth.

Block 120 comprises identifying any item(s) that the user has recently selected in one of several different contexts, according to the embodiment, as discussed in previous sections. Zero or more items may be identified.

Block 130 comprises detecting a user state based at least on the items identified in block 120 (if any) and/or the location data of block 110. The user's state characterizes the context under which the user is accessing the shopping list management application and/or the coupon distribution component. For example, if a user has a number of items that are needed for a specific recipe, a recipe-shopping state may be identified for the user. Other states might include a state for regular or semi-regular grocery shopping, a state for running a quick errand, a state for buying party items, a state for buying school supplies, and so forth. Other factors may also be utilized to identify a state, such as the time of week, time of year, weather forecasts, user or local event calendars, user preferences, and a history of previous states identified for a user. While possible techniques for detecting various example states are described elsewhere in this application, any number of possible states may exist, depending on the embodiment, and the states may be detected using any suitable technique.

In some embodiments, multiple states may be identified for a user. In other embodiments, the user's probability of being in each of the possible states is quantified, and the state with the highest probability is selected. In an embodiment, the state may be explicitly specified or overridden by user input selecting a state.

Block 140 comprises selecting a specific algorithm for recommending items based upon the state identified in block 130. In other words, different techniques or strategies are used to identify items for a user depending on a user's state. For example, each user state may be mapped to a different algorithm for selecting items to recommend. In an embodiment, a client-side shopping list management application makes a different type of application programming interface (API) call to a server-side recommendation engine, depending on the detected user state. Each different type of (API) call is associated with a different algorithm for identifying items to recommend to the user. Various example algorithms for identifying items to recommend to the user are described elsewhere in this application. However, any recommendation algorithms, including FP-Tree-based algorithms and Apriori-based algorithms, may be used.

Block 150 comprises identifying one or more items to recommend by performing the algorithm selected in block 140. The algorithm is performed by executing instructions that implement the algorithm using one or more processors at one or more computing devices, such as a server computer system or a mobile device. The algorithm may accept inputs based upon which the recommendations may be more personalized, including input indicating any of the items identified in block 120, the location data in block 110, coupon-related histories, shopping list histories, user characteristics and so forth. The algorithm outputs data describing the one or more recommended items. While some or all of the algorithms that could have been selected in block 140 may use the same inputs, the algorithms use these inputs differently, thus resulting in different algorithms producing different recommendations for the same inputs at least some of the time. Thus, all other factors being equal, a user may receive different recommendations while in a “recipe” state versus a “weekly grocery shopping” state.

The number of recommended items may vary depending on how many recommended items are found and the manner in which the recommended items are to be presented to a user. For example, if the items are to be presented to the user via a mobile device, the recommendations may be more limited in number than if the items are to be presented to the user on a personal computing device with a larger screen. In some embodiments, the number of recommended items is set to a maximum number regardless of the intended manner of presentation, and it is up to the presenting application to decide how many recommendations to actually display.

Block 160 comprises presenting information about the recommended items and/or coupon offers associated with the recommend items to the user. For example, in an embodiment, a shopping list management application may display a prompt to the user indicating that there are recommendations for the user. The user may select this prompt and view the information about the recommended items. The user may then add the recommended items to a shopping list and/or obtain associated coupons. In an embodiment, the information may be displayed to the user when the user launches a coupon browsing interface. In an embodiment, the information may be emailed to the user.

In an embodiment, the items may be automatically added to a shopping list. Or, coupon offers may automatically be added to a list of coupons available to the user. The recommended items and/or coupon offers may or may not be highlighted or otherwise differentiated from other items and/or coupon offers to indicate to the user that the items are recommendations. In an embodiment, the user is nonetheless required to indicate whether the user actually wants to add each recommended item to a shopping list, or wants to obtain a coupon for each recommended coupon offer. If the user does not so indicate, the recommendation will be removed after a default period of time.

Flow 100 is one example technique for identifying items to recommend based on user states and other techniques may involve fewer, additional, or different elements in varying orders. For example, block 120 may be performed before block 110. As another example, block 120 may be generalized to identifying specific actions performed by a user over a recent period of time, including adding specific items to shopping list, accessing the shopping list in general, printing the shopping list, marking certain shopping list items as being in the user's basket, and so forth. In an embodiment, state detection is further based on the order in which items were selected by a user.

2.2. Detecting a “Recipe” State and Recommending Items Based Thereon

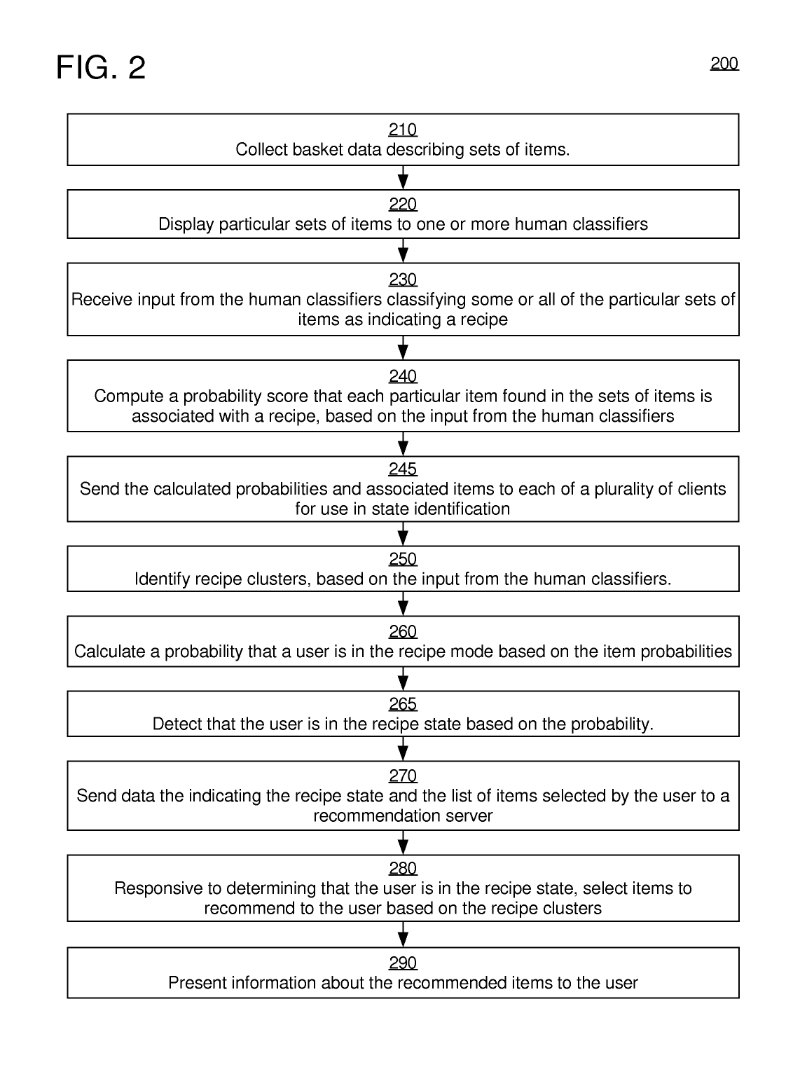

FIG. 2 illustrates a flow 200 for detecting when a user is in a recipe state and recommending items based on that state, according to an embodiment.

Block 210 comprises collecting basket data describing sets of items. Each of the sets of items is a set of items that were selected by one or more users. In an embodiment, multiple permutations of items from particular transactions, shopping lists, or coupon sets may be added to the basket data. For example, if items A, B, and C were purchased in a transaction, the sets of items added to the basket data may include {A, B, C}, {A,B}, {A,C}, {B, C}, {A}, {B}, and {C}. In other embodiments, only the set {A,B,C} would be added.

Block 220 comprises displaying particular sets of items collected in block 210 to one or more human classifiers. The human classifiers will have been instructed to analyze each of the sets to determine whether, in their judgment, the items were likely selected for use in a recipe. In an embodiment, the human classifiers are instructed to identify a set of items as being selected for use in a recipe even if the recipe calls for other items not in the set. Thus, for some recipes with highly distinctive items, even a set having but a single item may suggest a recipe. In an embodiment, the human classifiers are instructed to identify a set of items as being selected for use in a recipe only if the recipe does not call for other items not in the set.

Block 230 comprises receiving, in response to performance of block 220, input from the human classifiers classifying some or all of the particular sets of items as indicating a recipe. For example, the input may classify a set of items consisting of lettuce, walnuts, and salad dressing as a recipe (e.g. “Walnut salad”), but classify a set of items consisting of lettuce, chocolate chips, milk, and walnuts as not being a recipe. Input may be received for each item set from multiple users, or from just a single user, depending on the embodiment. Input may comprise binary responses (i.e. “yes” or “no”), or may take the form of a sliding scale indicating the human-classifier's confidence that the items were selected for a recipe.

In an embodiment, blocks 220 and 230 are crowd-sourced through, for example, a third-party human intelligence task service.

Block 240 comprises computing a probability score that each particular item found in the sets of items is associated with a recipe, based on the input from the human classifiers that was received in block 230. The probability score may be calculated using a variety of techniques. For example, the probability score may simply be the number of times that an item set in which the item appeared was classified as a recipe, divided by the number of times an item set in which the item appeared was considered by a human classifier. More complicated score calculations may occur, particularly when the input of block 230 constitutes more than binary responses.

Block 245 optionally comprises sending the calculated probabilities and associated items to each of a plurality of clients for use in state identification. For example, a recommendation server may periodically send updated probability information to smartphone applications so that the smartphone applications may detect the recipe state from a shopping list or set of coupons. However, block 245 is not performed in embodiments where state identification occurs at the server, or where state identification does not occur at all.

Block 250 comprises identifying recipe clusters, based on the input from the human classifiers that was received in block 230. The recipe clusters are sets of items that frequently co-occur in sets that are identified as being associated with recipes. In this context, “co-occur” means to occur together or to be found together. In an embodiment, each set that is identified as likely to have been selected for a recipe is considered to be a recipe cluster. In other embodiments, rather than simply trust each human classification, various clustering techniques may be used to identify the recipe clusters, including without limitation k-means clustering.

Block 260 comprises calculating a probability that a user is in the recipe mode based on the item probabilities calculated in block 240 and a set of items that is currently selected by a user. For example, the set of items may be those items that are in a currently active or recently created shopping list. As another example, the set of items may be a set of unused coupons recently requested by the user. The set of items optionally may be specific to a recent period of time, such as the last day or last few hours, as discussed in previous sections. The probability is a function of the probabilities of the items in the set. An example function is an average. Items that are not associated with any probability are ignored.

Block 265 comprises detecting that the user is in the recipe state based on the probability calculated in block 260. For example, if the probability calculated in block 260 is greater than a pre-defined threshold, the user may be determined to be in the recipe state. As another example, if the probability calculated in block 260 is greater than any probability calculated for any other enumerated state, the user may be determined to be in the recipe state.

Block 270 optionally comprises sending data indicating the recipe state and the set of items currently selected by the user to a recommendation server. Block 270 is performed at a client device, when the client device is responsible for determining the state of the user, but not responsible for recommending items. Block 270 is not performed in other embodiments.

Block 280 comprises, responsive to determining that the user is in the recipe state, selecting items to recommend to the user based on the recipe clusters. For example, if a set of currently selected items includes {A,B}, and a recipe cluster includes {A,B,C,D}, the user may receive recommendations for items C and D, for coupons related to items C and D, or for items in a category associated with C or D. If the currently selected set of items includes items mapped to different recipe clusters, recommended items may be selected from all recipe clusters, or from a highest ranked recipe cluster. Any suitable ranking algorithm may be utilized to rank the recipe clusters.

Block 280 may be performed, for example, at a recommendation engine on a server. Or, in an embodiment, the recipe clusters may have been communicated to a client in block 245. In such cases, block 280 may be performed by the client.

Block 290 comprises presenting information about the recommended items to the user, as occurs in block 160. If block 280 was performed at a server, block 290 may further comprise sending data describing the recommended items to the user's client device.

A “recipe” state is one example of a state that may be identified in flow 100. Various embodiments may feature an enumerated “recipe” or similar state. However, other embodiments may not feature such a state, and thus would not perform the elements of flow 200. In yet other embodiments, fewer, additional, or different steps may be utilized to recognize a recipe state and provide recommendations based thereon, in potentially different orders. For example, once a recipe state has been detected in block 265, other algorithms besides that depicted in blocks 280 may be utilized to recommend items for the recipe state, including other algorithms described herein. For example, the algorithm may be configured to at least sometimes recommend items that are not related to the recipe clusters.

As another example, a database of actual recipes may be substituted for the human input of block 230, and thus blocks 210 and 220 are not necessary. In other embodiments, a database of actual recipes supplements the crowd-sourced recipe data. For example, each actual recipe may be treated as a recipe cluster, and/or the occurrence of an item in one or more actual recipes may increase the probability calculated for that item in block 240.

In other embodiments, the probability calculations of block 240 are not necessary. The probability that a user is in recipe mode is calculated in block 260 entirely from a comparison of the set of items currently selected by a user to the recipe clusters. In a stateless embodiment, there is no need to detect a recipe state. Items are recommended exclusively based on recipe clusters computed using the techniques described herein.

2.3. Identifying a Chain of Recommended Items

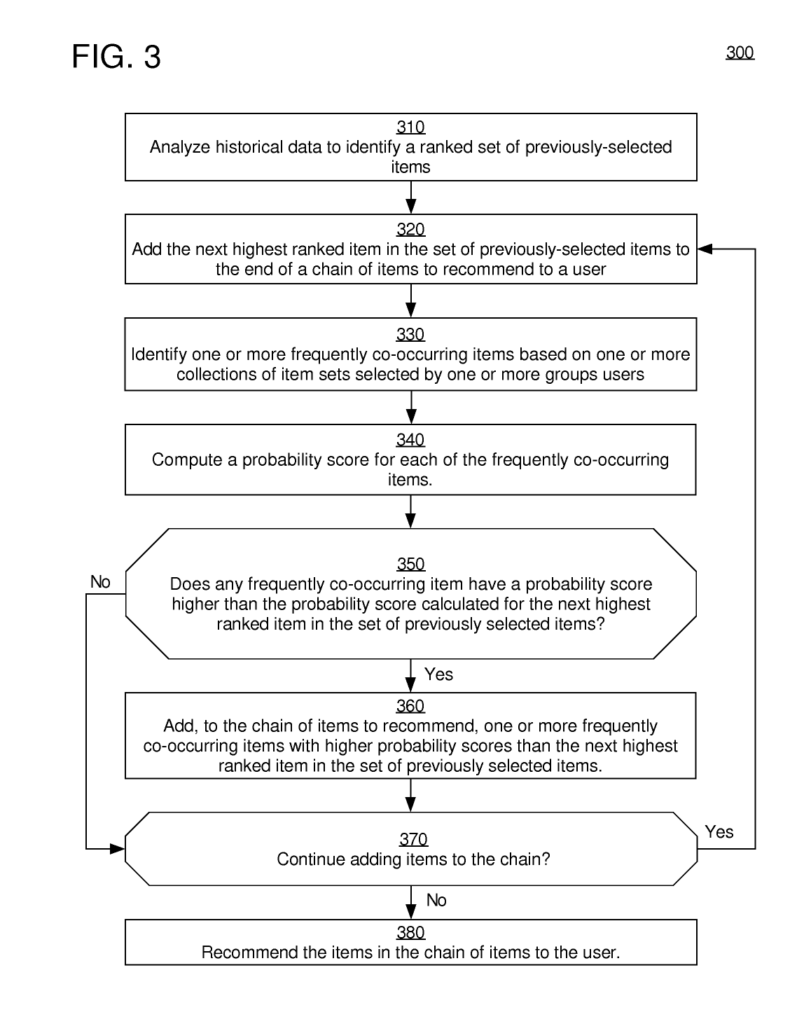

FIG. 3 illustrates a flow 300 for identifying a chain of items to recommend to a user, according to an embodiment. The chain is an ordered list. The ordering may be used to determine how to present the recommended items; for example, an order of presentation may be determined. The ordering may also or instead be used to determine which items to present to the user, in embodiments where it is desirable to only recommend a limited number of items.

Block 310 comprises analyzing historical item data or coupon data to identify a ranked set of previously-selected items. The ranked set comprises items that a user has selected in the past, as indicated by the historical data. The items may be ranked by any suitable ranking function, depending on the recommendation algorithm. For example, one recommendation algorithm may utilize a ranking function that simply ranks items by the number of times the user has selected them. Another algorithm may utilize a time-decaying function of this number, so that selection within the last week is more important than selection a year ago. Other algorithms may incorporate other features into this ranking function, including features related to the location of the user, the time of day, the time of week, the current season, behavior of users having similar demographics, and coupon campaign targeting data.

Block 320 comprises adding the next highest ranked item in the set of previously-selected items to the end of a chain of items to recommend to a user. If this is the first iteration of block 320, block 320 comprises making the highest ranked item in the set of previously-selected items the first item in the chain of items to recommend to the user. Otherwise, the highest ranked item from the set of previously-selected items that is not already in the chain of items is added to the end of the chain of items to recommend to the user.

Block 330 comprises identifying one or more frequently co-occurring items based on one or more collections of sets of items (“item sets”) selected by one or more groups users. A co-occurring item is an item found in at least one item set that also includes the item that was added to the chain in block 320. For example, if a user has previously selected both an item A and an item B at the same time, then if the item added in block 320 is item A, a co-occurring item identified in block 330 may be item B. Depending on the embodiment and/or the recommendation algorithm, the sets of items selected by other users that are analyzed for co-occurring items may include items that are found together in any or all of shopping lists, transactions, recipe clusters, and sets of coupons requested within a certain period.

Each item that co-occurs with an item in the ranked set of co-occurring items is assigned a co-occurrence score relative to the collection from which the co-occurring was identified. The co-occurrence score for an item may be determined by a ranking function that is based on at least the frequency of co-occurrence in the analyzed sets of the corresponding collection. The co-occurrence score might also be based on factors such as the number of other items in the ranked set of previously-selected items with which the item co-occurs, how often the item co-occurs with multiple items in the ranked set of previously-selected items, and so forth. The co-occurring item with the highest co-occurrence score for a collection is then selected as a frequently co-occurring item for the purposes of block 330.

While in some embodiments only a single collection is analyzed for co-occurring items, in other embodiments, the process is repeated for different collections of item sets collected from different groups of users, thus resulting in a plurality of co-occurring items. For example, one co-occurring item may be selected based on collection of items sets selected by a global set of users, while another co-occurring item may be selected based exclusively on a collection of items sets pertaining to a particular demographic market area or zip code in which the user is currently located, while yet another co-occurring item may be selected based exclusively on a collection of items sets selected by users of a certain gender. Consequently, some or all of the co-occurring items may have co-occurrence scores that are relative to different collections of item sets collected from interactions with different groups of users.

In an embodiment, the analysis of the collections of item sets occurs in advance of blocks 310-320. For each collection, a co-occurrence score is calculated for each item found in the sets relative to each other item found in the sets. A variety of suitable techniques for calculating such a co-occurrence score may be used. The pre-determined co-occurrence score may be stored and updated over time, based on new sets of items selected by users. Block 330 may then simply comprise selecting items based on these pre-calculated co-occurrence scores. Or, block 330 may comprise using pre-determined co-occurrence scores to calculate a relative co-occurrence score that is relative to the items in the ranked set of block 310.

Block 340 comprises computing a probability score for each of the frequently co-occurring items. The probability score approximates the probability that the user will select a co-occurring item. In some embodiments, the probability score for a co-occurring item is simply the co-occurrence score. In other embodiments, the probability score is a normalized version of the co-occurrence score that is suitable for comparing to the probability scores calculated for the set of previously-selected items in block 310. In other embodiments, the probability score is a function of the co-occurrence score along with other parameters, such as the time of day, time of week, state of the user, user history, user preferences, demographic characteristics of the user, and so forth.

Block 350 comprises determining whether any frequently co-occurring item has a probability score, as calculated in block 340, that is higher than the probability score calculated for the next highest ranked item in the set of previously selected items, as calculated in block 310, where the next highest ranked item is not in the chain of items. If so, then flow proceeds to block 360. If not, flow proceeds to block 370.

Block 360 comprises adding, to the chain of items to recommend, one or more frequently co-occurring items with higher probability scores than the next highest ranked item in the set of previously selected items. All such frequently co-occurring items may be added to the chain, or merely the highest scoring of the frequently co-occurring items may be added to the chain.

Block 370 comprises determining whether to continue adding items to the chain. If a terminal condition has not been reached, then flow returns to block 320. Otherwise flow proceeds to block 380. Terminal conditions may include some or all of adding a predetermined number of items to the chain, exhausting the ranked set of previously selected items, determining that the next highest ranked item not already in the chain is below a threshold probability score, and so forth. The predetermined number of items to add to the chain may vary depending on the type of client being used by the user and/or the state of the user. In an embodiment, block 370 may also or instead be performed in between blocks 320 and 360, so that terminal conditions are checked after adding each new items to the chain.

Block 380 comprises recommending the items in the chain of items to the user, as occurs in block 160 of FIG. 1. The recommended items are prioritized in the order in which they were added to the chain.

Flow 300 is an example of a specific algorithm that may be used for a specific state, per blocks 140-150 of FIG. 1. Additional algorithms may be derived by adding, removing, modifying, or rearranging elements of flow 300. For example, different algorithms may be formulated by calculating the probabilities of block 310 and 340 in different ways. That is an algorithm for a first user state may be configured to use features relevant to an item A in such manner as to result in calculating a higher probability for item A than an algorithm for a second state. As another example, the analysis of block 330 may vary from algorithm to algorithm. As another example, the items identified in block 310 may include all items that the user has ever selected, or may be limited to a certain time period. For instance, block 310 of an algorithm for one user state may only identify items that the user has selected within the last month, whereas block 310 of an algorithm for another user state may identify items that the user has selected within the past year.

In an embodiment, randomly or pseudo-randomly selected items may be periodically added to the chain. For example, flow 300 may comprise an additional element of utilizing a random number generator after certain step(s) to determine whether to add to the chain an item that would not normally be recommended. This step may be utilized to, among other purposes, recommend items that are new to the market.

In an embodiment, instead of ranked sets of previously-selected items and co-occurring items, flow 300 is performed with respect to ranked sets of previously-selected groups of items and co-occurring groups of items. Groups of items may be based on, for example, associative data such as categorical data from manufacturers or other entities, clusters identified via k-clustering mechanisms, and so forth. Block 310 may comprise computing probability scores on a group basis; for example, averaging items belonging to the group may be performed. Block 320 may comprise selecting the next highest ranked group of items. A single item from that group, for example, a highest scoring item, randomly selected item, or an item that is found in the user's current location, is then added to the chain. Similarly, block 330 may comprise calculating co-occurrence scores for a group of items. Block 360 may then comprise identifying a highest scoring co-occurring group. An item from the co-occurring group is then added to the chain.

2.4. Calculating Cycle-Based Probabilities and Recommending Items Based Thereon

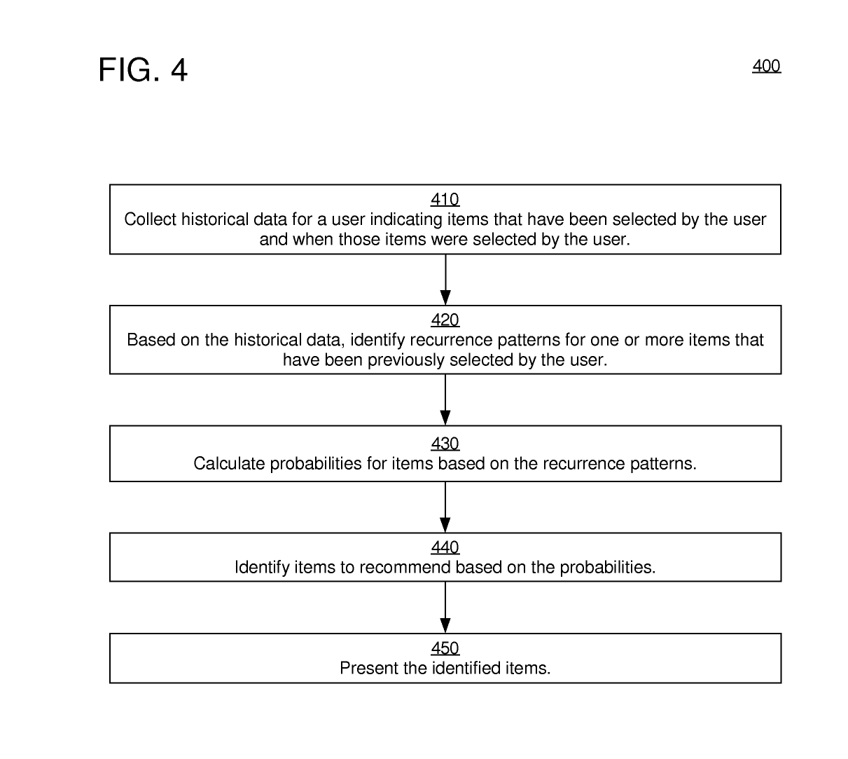

FIG. 4 illustrates a flow 400 for calculating cycle-based probabilities for items and recommending items to a user based thereon, according to an embodiment.

Block 410 comprises collecting historical data for a user indicating items that have been selected by the user and when those items were selected by the user.

Block 420 comprises, based on the historical data, identifying recurrence patterns for one or more items that have been previously selected by the user. In an embodiment, each recurrence pattern comprises a cycle of time over which the pattern occurs along with an indication of one of more windows of time, for example, a set of days, within the cycle when the user is expected to once again select the item. Thus, for example, if a user consistently requests a coupon for milk within a certain period of time surrounding the second Tuesday of each month, the pattern may include a window of time indicating that a milk item may be recommended to the user starting, for instance, a day in advance of the second Tuesday, and ending, for instance, a day after the second Tuesday, or when the user actually requests a milk coupon.

The identified pattern may be of arbitrary complexity. For example, the cycle may occur over an entire year, and comprise different phases for different periods of the year. Examples of periods include months, seasons, quarters, holidays. The frequency of windows of time during which a user is expected to purchase an item may change depending on the phase. For example, based on the user's history, an item such as allergy medication may be recommended every two weeks during a “spring” phase, every three weeks during a “summer” phase, and not at all during other phases.

Block 420 may be repeating process. For example, new patterns may be identified for the user on a weekly, daily, or other basis. Any suitable pattern matching technique may be used to identify the recurrence patterns.

Block 430 comprises calculating probabilities for items based on the recurrence patterns. A current point within each item's cycle is identified based on the prior selection history of the user. Items that are not within their likely selection window are assigned a probability of zero. Items that are within their selection window are assigned a probability that is relative to how close the current time is to the mid-point of the window. For example, items may be assigned a probability on a bell curve or other distribution relative to the selection window.

In an embodiment, items that do not have recurrence patterns are ignored for the purposes of block 430. Alternatively, recurrence patterns for other users having similar characteristics may be used, but weighted so that items having a user-specific recurrence pattern are preferred. In an embodiment, the probability score for an item may be weighted based on factors such as a confidence score in the recurrence pattern, the existence of coupons for the item, recurrence patterns of other users, the current location of the user, and so forth.

Block 440 comprises identifying items to recommend based on the probabilities calculated in block 430. In an embodiment, only a set of items with the highest probabilities is selected. In an embodiment, any item with a probability greater than a threshold, such as zero, may be recommended.

Block 450 comprises presenting the items identified in block 440, as occurs in block 160 of FIG. 1. The recommended items are prioritized in the order of their probability scores.

Flow 400 is yet another example of an algorithm that may be used for specific states, per blocks 140-150 of FIG. 1. Other cycle-based algorithms may also be used, comprising additional, fewer, or different elements in potentially different orders. Furthermore, the cycle-based probabilities calculated in block 430 may also be utilized as factor(s) in other probability scores for other algorithms, including other algorithms described herein.

### 3.0. Structural Overview

3.1. Example System with Client-Based State Identification

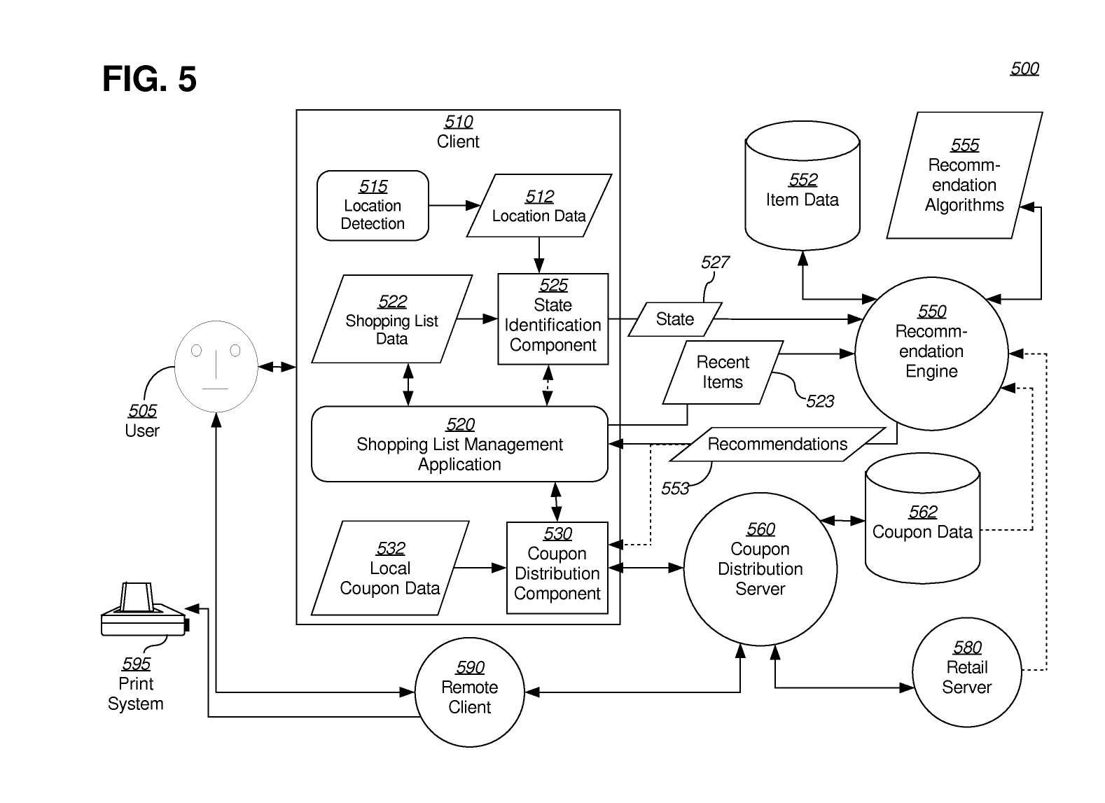

FIG. 5 illustrates an example system 500 with client-based state identification, in which the techniques described herein may be practiced according to an embodiment. System 500 comprises a client device 510 which is operated by a user 505. Client 510 may be, for example, a mobile computing device such as a smartphone or tablet. Client 510 is coupled by one or more network interfaces to one or more wide-area networks, such as the Internet. Client 510 comprises, among other elements, one or more location detection components 515, which generate location data 512. The one or more location detection components 515 may include, for example, a GPS component that generates location data such as coordinates based on triangulating signals from satellites. Location detection components 515 may further or alternatively include components that generate location data by comparing identifiers associated with cellular, wifi, or other wireless signals to databases of coordinates. Location detection components 515 may also or alternatively include any other suitable mechanism(s) for generating location data as described herein.

### Shopping List Management Application

User 505 utilizes client 510 to, among other purposes, create, maintain, and access one or more shopping lists. Client 510 executes a shopping list management application 520 that provides user 505 with interface(s) for viewing a shopping list, adding an item to a shopping list, removing an item from a shopping list, marking items on a shopping list as purchased, and/or performing other actions associated with a shopping list. Shopping list management application 520 stores any shopping lists created by user 505 in the form of shopping list data 522 in a local repository such as a file or database. Any suitable storage technique may be utilized for shopping list data 522. In some embodiments, shopping list data 522 is stored on a server from which it may be shared with other devices, such as remote client 590. In such embodiments, a local copy of shopping list data 522 may be cached at client 510 and synchronized with the shopping list data 522 on the server.

Shopping list management application 520 is optionally configured to provide interface(s) that recommend items of interest to user 505. For example, shopping list management application 520 may show recommended items adjacent to a shopping list created by the user 505. Or, as another example, shopping list management application 520 may create a system notification informing user 505 of a recommended item. The interface(s) may allow a user to add the item to a shopping list, search for coupon offers related to the item, and/or request a coupon for the item. The recommended items are items described in recommendation data 553, which is received over a wide area network from a recommendation engine 550, as described below.

### Client-Side Coupon Distribution Component

User 505 may also optionally utilize client 510 for viewing coupon offers and requesting digital coupons for those coupon offers. For this and other purposes, client 510 may execute a coupon distribution component 530. Coupon distribution component 530 downloads and stores local coupon data 532 in a local repository such as a file or database. Any suitable storage technique may be utilized for coupon data 532. Local coupon data 532 may comprise, for example, data describing one or more coupon offers, including offer terms such as coupon value, coupon-eligible products, and expiration dates, and/or data describing actual coupons that have been distributed to a user via print or electronic media. Coupon distribution component 530 provides interface(s) by which user 505 may search for and/or view information about coupon offers and/or coupons described in coupon data 532. Coupon distribution component 530 further provides interface(s) by which user 505 may request printed or electronic coupons for coupon offers described in coupon data 532. In an embodiment, coupon distribution component 530 further provides interface(s) by which a user may redeem electronic coupons while shopping.

Coupon distribution component 530 communicates over a wide area network with a coupon distribution server 560 to retrieve local coupon data 532. In turn, the coupon distribution sever 560 is coupled to global coupon data 562 stored in a database or other repository. Local coupon data 532 is, in an embodiment, a cache of this global coupon data 562. Via coupon distribution component 530 and coupon distribution server 560, local coupon data 532 is synchronized automatically or on-demand with global coupon data 562. Global coupon data 562 may, in some embodiments, include information about coupon offers that are not described in local coupon data 532. Coupon distribution component 530 may include interface(s) for searching for information about coupon offers via coupon distribution server 560, and then downloading information about the coupon offers to local coupon data 532 responsive to the search. Coupon distribution component 530 may further include interfaces for requesting that coupon distribution server 560 generate and/or distribute coupons to user 505.

The combination of coupon distribution component 530 and shopping list management application 520 in client 510 integrates coupon functionality with shopping list management. For example, coupon distribution component 530 may allow a user to locate coupons based at least in part on the items in a shopping list. As another example, items associated with coupons that a user has requested through coupon distribution component 530 may automatically be added to a shopping list in shopping list management application 520. Coupon distribution component 530 may thus be an integrated component of shopping list management application 520, or coupon distribution component 530 may be a separate application that interfaces with shopping list management application 520 via a suitable API. Examples of integrations between suitable shopping list management applications and coupon distribution components are described, for example, in the previously cited publication, “COUPON INTEGRATION WITH SHOPPING LISTS.”

Coupon distribution component 530 may optionally be configured to provide interface(s) that recommend coupon offers of interest to user 505. For example, coupon distribution component 530 may show recommended coupon offers at the top of a list of other coupon offers that are available for user 505. Or, as another example, coupon distribution component 530 may create a system notification informing user 505 of a recommended coupon offer. The interface(s) may allow a user to request a coupon for the recommended coupon offer. The recommended coupon offers are items described in recommendation data 553, which is received over a wide area network from a recommendation engine 550, as described below.

### Coupon Distribution Server

System 500 optionally comprises coupon distribution server 560. Coupon distribution server 560 is operated by a coupon distributor for, among other purposes, making coupons available to users such as user 505. In an embodiment, a server may refer to one or more applications executing on one or more computers or devices that interact with counterpart client applications executing on other computers or devices. Thus, coupon distribution server 560 may be one or more server applications, executing at one or more computing devices operated by a coupon distributor.

Coupon distribution server 560 receives and responds to coupon-related requests from clients such as clients 510 and 590 over one or more networks, such as the Internet. Coupon distribution server 560 retrieves some or all of coupon data 562 to respond to various requests from client 120. For example, client 510 may request that coupon distribution server 560 provide a listing of available coupons, search for a coupon based on keywords, or save an electronic coupon to the user account for user 505. In response, coupon distribution server 560 may retrieve any relevant coupon data 562, process the coupon data 562 as appropriate, and, based on that processing, formulate a response to the client.

In an embodiment, coupon distribution server 505 is further configured for distributing printable coupons. For example, coupon distribution server 560 may distribute a PDF, postscript, or other print-ready file to client 510. User 505 may then may print this file to obtain a coupon. In an embodiment, responsive to a request from coupon distribution component 530, coupon distribution server 560 may send printing instructions to remote client 590. User 505 may then operate remote client 590 to print a coupon at print system 595. For example, client 510 may be a mobile phone, whereas remote client 590 may be a desktop computer. While any suitable technique for distributing printable coupons may be used, examples of architectures that are suitable for distributing printable coupons via coupon distribution server 560 are described in, for instance, U.S. Patent Publication Number 2011/0313836 A1, titled “Controlling Coupon Printing To Multiple Types Of Clients,” the contents of which are hereby incorporated by reference for all purposes as if set forth in their entirety.

In other embodiments, coupon distribution server 560 need not necessarily be capable of distributing printable coupons. Rather, coupon distribution server 560 facilitates the availability of user-selected coupon offers at a point-of-sale without requiring user 505 to actually present a physical coupon. Accordingly, coupon distribution server 560 generates one or more types of “electronic coupons.” For example, in an embodiment, coupon distribution server 560 generates files or database records describing different coupons, which are then communicated to client 510 for presentation to a retailer.

As another example, in an embodiment, coupon distribution server 560 generates “electronic coupons” for user 505 in the form of information about one or more coupon offers that are associated with an identifier of user 505 such as a store loyalty card or radio-frequency identifier. The user may provide this identifier in place of a coupon when engaging in a transaction at a point-of-sale. While any suitable technique for distributing electronic coupons may be used, examples of architectures that are suitable for distributing electronic coupons via coupon distribution server 560 are described in, for instance, U.S. Patent Publication 2012/0066047 A1, titled “Identifier-Based Coupon Redemption,” the contents of which are hereby incorporated by reference for all purposes as if set forth in their entirety.

Coupon distribution server 560 may store global coupon data 562 in one or more databases and/or file repositories. Among other aspects, coupon data 562 may comprise, for each coupon offer, data such as the name of the coupon provider making the coupon offer, distribution parameters, terms of the coupon offer, print layout information and graphics, one or more internal or provider identification numbers, bar code generation information, one or more relevant uniform resource locators (URLs), one or more coupon names or titles, one or more related search terms, and one or more related categories. Distribution parameters may include aggregate distribution limit values, per device distribution limit values, or per client distribution limit values.

Global coupon data may further include or be associated with user account and distribution data. This data may be used, among other aspects, to track how many times client 510 and/or user 505 has printed coupons for, viewed, and/or saved each coupon offer described in coupon data 562. This data may further be used to facilitate redemption of electronic coupons as described above. For example, each user account may be associated with data identifying which electronic coupons are currently available to a user. This data may be shared with retailers. For example, a list of electronic coupons “clipped” by user 505 may be sent to retail server 580.

### State Identification Component

Client 510 comprises a state identification component 525. State identification component may be a component of shopping list management application 520, or may be an entirely separate component of client 510. State identification component 525 has access to at least one of the shopping list data 522, location data 512, or coupon data 532. In some embodiments, state identification component 525 may also have access to a history of interactions between the shopping list management application 520 or coupon distribution component 530 with user 505, including actions unrelated to the items in the shopping list. State identification component 525 is configured to send an identified state 527 to a recommendation engine 550 either directly, via shopping list management application 520, or via coupon distribution component 530.

State identification component 525 comprises executable logic for analyzing shopping list data 522, coupon data 532, location data 512, and/or other application interaction data. State identification component 525 further comprises executable logic for, based on the analysis, categorizing user 505 as being in at least one of a plurality of enumerated states. For example, state identification component 525 may identify user 505 as being in a “grocery” state or “recipe” state pursuant to the techniques described herein. In an embodiment, state identification component 525 may have access to local or server-based item associative data, such as item clusters or co-occurrence probabilities, to assist state identification component 525 in using shopping list data 522 to identify a state.

State identification component 525 may optionally include a machine learning component for using feedback from shopping list management application 520, coupon distribution component 530, and/or other components of client 510 (e.g. a payment processing application) to personalize its identification logic to the user. State identification component 525 may also include logic for receiving customizations to the identification logic from a server, such as a server executing recommendation engine 550.

### Recommendation Engine

System 500 comprises a recommendation engine 550. Recommendation engine 550 comprises one or more server processes at one or more computing devices that provide recommendation data, such as recommendation data 553, to clients such as client 510. Recommendation engine 550 may be integrated into coupon distribution server 560, or may be implemented by a separate server. Recommendation data 553 comprises data identifying one or more items to recommend to user 505. Shopping list management application 520 and/or coupon distribution component 530 utilize the recommendation data 553 to provide recommendations to the user, as described above.

Recommendation engine 550 is configured to receive state data, such as state 527, and optionally recent item data, such as recent items 523, from clients, such as clients 510. In an embodiment, recommendation engine 550 receives state 527, recent items 523, and other data over a wide area network via Hypertext Transfer Protocol (HTTP) messages. However, any suitable communication mechanisms may be used. Recommendation engine 550 is also configured to provide to client 510, over a wide area network, with potentially different recommendation data 553 depending on the state 527. To this end, recommendation engine 550 uses the state 527 to select an algorithm from recommendation algorithm data 555 for generating recommendation data 553.

Recommendation algorithms 555 comprises a plurality of instruction sets, each instruction set describing a particular algorithm for generating recommendation data 553. Each algorithm 555 performs different steps for selecting items from item data 552. The different algorithms may include a number of different parameters, including without limitation recent items 523, previous transaction data such as data from retail server 580, or coupon-related tracking data, such as stored in coupon data 562.

Recommendation engine 550 may provide recommendation data 553 at any time requested by shopping list management application 520 or coupon distribution component 530. Requests for recommendation data 553 may include one or both of state 527 and recent items 523. For example, requests for recommendation data 553 may take the form of parameterized API calls to recommendation engine 550. In an embodiment, recommendation engine 550 receives state 527 and/or recent items 523 separate from any request for recommendation data 553. The state 527 and/or recent items 523 is stored for use in future requests for recommendation data 553, which therefore do not need to include state 527 and/or recent items 523. In an embodiment, requests for recommendation data 553 include identification data for client 510 and/or user 505 so that the selected recommendation algorithm 555 may utilize input parameters comprised of data associated with client 510 and/or user 505. In an embodiment, recommendation engine 550 periodically pushes recommendation data 553 to client 510.

In an embodiment, recommendation engine 550 is provided by a different entity than shopping list management application 520 and/or coupon distribution component 530. For example, recommendation engine 550 may be a recommendation service hosted by a coupon distributor for providing recommended items to a variety of different types of third-party applications, including both client-based applications and server-based applications. Recommendation engine 550 may thus expose a public API for receiving requests and providing recommendation data 553 over a wide area network.

Item data 552 describes a plurality of products, services, and/or coupon offers. Item data 552 may include or overlap with coupon data 562. Item data 552 may be stored in any suitable form, including databases or file repositories. In an embodiment, at least some of item data 552 is stored by a third-party service provider, such as an online shopping database, rather than the owner/operator of recommendation engine 550. Any suitable technique of retrieving the third-party data may be utilized.

Item data 552 may include, for each described item, one or more of: identifiers such as UPCs and model numbers, textual descriptions such as titles and reviews, associated coupon offers, prices, and so forth. Item data 552 may further include associative data that identifies associations between items. These associations may include, for example, data that defines sets of items such as categories, recipes, or frequent item sets. The data may be obtained from transaction histories or coupon tracking logs. In at least some embodiments, some of the associative data, such as frequent item sets, differs depending on the user 505. In an embodiment, the associative data may evolve over time via feedback to the recommendation engine from, for example, retail server 580.

### Variations

System 500 is but one example of a system for practicing the described techniques. Other systems may include additional, fewer, or different elements in varying arrangements. For example, other systems will typically include more client, users, and retail servers. In some systems, the distribution of components between client and server may differ. For example, the recommendation engine may reside on client 510. In an embodiment, state identification component 525 resides at least partially at a server rather than at client 510. Client 510 is thus configured to send to the server data such as location data 510, or data derived therefrom, in order to allow state identification component 525 to identify state 527. In some embodiments, system 500 may only support recommended items that are coupon offers, or only support recommended items that are shopping list items. In some embodiments, system 500 only comprises shopping list components, or only comprises coupon distribution components.

3.2. Example System with Server-Based State Identification

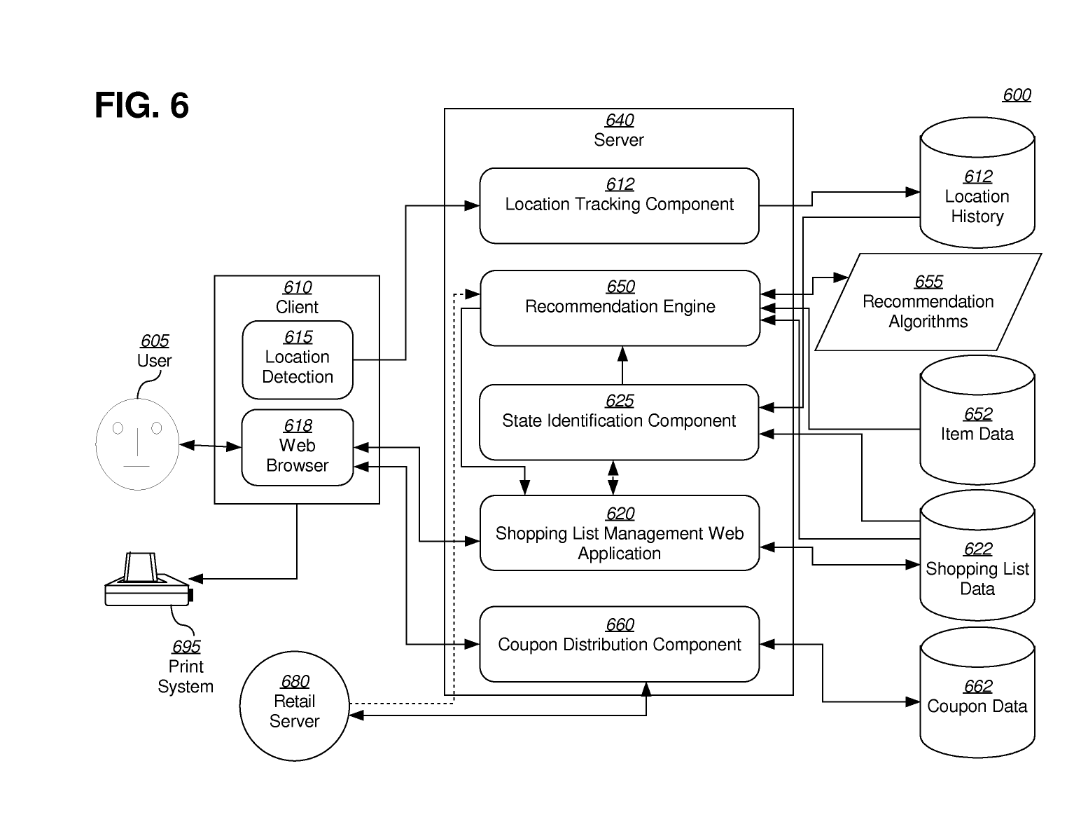

FIG. 6 illustrates a block diagram of another example system 600, having server-based state identification, in which the techniques described herein may be practiced according to an embodiment. System 600 comprises a client device 610 which is operated by a user 605. While client 610 may in many respects be similar to client 510, client 610 does not comprise a dedicated shopping list management application or coupon distribution component. Rather, client 610 comprises a web browser 618 by which the user 605 accesses similar components on a server 640.

Server 640 is a set of one or more computing devices that collectively execute processes that implement the depicted components of server 640. These components include a location tracking component 612, a recommendation engine 650, state identification component 625, shopping list management web application 620, and a coupon distribution component 660.

Location tracking component 612 receives data generated by location detection component 615 of client 610 and, after optionally processing the data, stores location history data 612. Location history data 612 is similar to location data 512, except that is stored at a location that is stored elsewhere than at client 610—for example, in a database that accessible only to server 640. Location detection component 615 is similar to location detection component 515. Location detection component 615 may provide updated data to location tracking component 612 periodically, or in response to certain triggers. Alternatively, updated data from location detection component 615 is provided to location tracking component 612 indirectly, by web browser 618 including such updated data with requests to server 640.

Shopping list management web application 620 is functionally similar to shopping list management application 520. However, the interfaces provided by shopping list management web application 620 are web-based. Shopping list management web application 620 may be, for example, a web application executed on a web application server, a standalone application with built-in web server functionality, or a standalone application that interfaces with a separate web server at server 640. Web browser 618 sends HTTP requests (or other suitable requests) to shopping list management web application 620 (or a corresponding web server). Responsive to the HTTP requests, shopping list management web application 620 generates various web pages and/or code snippets comprising instructions to web browser 618 for displaying various shopping list related interfaces, as described herein. Web browser 618 receives an HTTP response messages with the generated web pages and/or code snippets. Web browser 618 then interprets the generated web pages and/or code snippets, thereby displaying shopping list related interfaces. The displayed interfaces in turn include controls that, when selected by user 605, cause web browser 618 to send additional HTTP requests requesting that shopping list management web application 620 perform various actions and/or return new interfaces.

Shopping list management web application 620 stores shopping list data 622. Shopping list data 622 is similar to shopping list data 522, except that shopping list data 622 is stored in a data repository external to client 610. For example, shopping list data 622 may be a server-side database of shopping lists associated with different users. User 605 may be required to “sign-in” to shopping list management web application 620 prior to accessing his or her shopping lists, so that the correct shopping list(s) for user 605 may be selected from shopping list data 622.

Coupon distribution component 660 is functionally similar to coupon distribution component 530. However, the interfaces provided by coupon distribution component 620 are similarly web-based. Coupon distribution component 660 may be, for example, a web application executed on a web application server, a standalone application with built-in web server functionality, or a standalone application that interfaces with a separate web server at server 640. Web browser 618 sends HTTP requests (or other suitable requests) to coupon distribution component 660 (or a corresponding web server). Responsive to the HTTP requests, coupon distribution component 660 generates various web pages and/or code snippets comprising instructions to web browser 618 for displaying various coupon-related interfaces, as described herein. Web browser 618 receives an HTTP response messages with the generated web pages and/or code snippets. Web browser 618 then interprets the generated web pages and/or code snippets, thereby displaying the coupon-related interfaces. The displayed interfaces in turn include controls that, when selected by user 605, cause web browser 618 to send additional HTTP requests requesting that coupon distribution component 660 perform various actions and/or return new interfaces. In an embodiment, coupon distribution component 660 and shopping list management web application 520 may be integrated components of the same web server or web application.

Coupon distribution component 660 stores coupon data 662. Coupon data 662 is similar to coupon data 562. For example, coupon data 662 may be a server-side database of shopping lists associated with different users. User 605 may be required to “sign-in” to coupon distribution component 660 prior to accessing his or her shopping lists, so that the correct coupon data for user 605 may be selected from coupon data 662.

Similar to coupon distribution component 560, coupon distribution component 660 may be coupled to a retail server 680.

State identification component 625 is functionally similar to state identification component 525. However, state identification component 625 identifies states at server 640 as opposed to client 610. Consequently, state identification component 625 uses server-side shopping list data 622, coupon data 662, and/or location history 612 to identify a current state for user 605. This state may be shared with recommendation engine 650, shopping list management application 620, and/or coupon distribution component 660. State identification component 625 may be integrated into shopping list management web application 620 and/or coupon distribution component 660.

Recommendation engine 650 is functionally similar to recommendation engine 550, as are recommendation algorithms 655 functionally similar to recommendation algorithms 555. However, recommendation engine 650 is server-based. Consequently, recommendation engine 650 receives state data from server-side state identification component 625 rather than client 610. Recommendation engine 650 further provides recommendation data to server-side components rather than to client 610. Recommendation engine 650 may, in some embodiments, even discover recent items directly from shopping list data 622 or coupon data 662. In an embodiment, state identification component 625 is integrated into recommendation engine 650. In an embodiment, recommendation engine 650 is integrated into shopping list management web application 620 and/or coupon distribution component 660.

Item data 652 is functionally similar to item data 552.

System 500 is but another example of a system for practicing the described techniques. Other systems may include additional, fewer, or different elements in varying arrangements. For example, in an embodiment, location history 612, item data 652, shopping list data 622, and coupon data 662 are all located in a same database. In an embodiment, one of coupon distribution component 660 or shopping list management web application 620 is optional. In an embodiment, various elements of coupon distribution component 660 are located client 610, such as a client-side print control for printing to a connected print system 695. A large number of variations in the distribution of components between client 610 and server 640 are possible, as should be clear from the examples of system 500 and system 600.

### 4.0. Implementation Examples

The examples given in this section are specific examples of implementations of the above techniques. Many other specific implementations of the above techniques are possible, each of which may have only some or even none of the specific features described in this section.

In an example embodiment, users have a bag of items in their grocery list which they store on a mobile application. The application, on launch, pings a backend server at regular intervals. The application logs the actions taken by the user up until the point the application pings the backend. The application is modeled as a state machine. The application follows user actions to decide the state of the user.

The application calls an appropriate backend API for the state of the user. For each state the user falls into, a different algorithm is chosen. Five user states are enumerated for use with the techniques described herein. The states include: 1) a recipe mode, detected as described with respect to FIG. 2; 2) a grocery shopping mode, detected based on comparing the current time and/or location to the location history of the user; 3) a grocery shopping mode with interests in coupons, detected when the user has recently accessed a coupon interface under similar conditions to state 2; 4) an errand mode for shopping for a small set of items, based on detecting that more than a certain number of items was very recently added to a shopping list; and 5) a default mode. An algorithm similar to those described with respect to flow 200 is used for the first mode. Algorithms similar to those described with respect to flow 300 are used for the second and third modes. However, the algorithms used for the second and third modes differ at least with respect to the sets of items analyzed or recommended (e.g. coupons are deemphasized or not recommended at all in the second mode). An algorithm similar to those described with respect to flow 400 is used for the fourth mode. A default mode based on local item popularity is used for the fifth mode.

In an example embodiment, an algorithm for coupon recommendations is designed to optimize a function “f”. The function is designed to maximize the probability that a coupon will be printed if it is served as a recommendation. The choice of what coupon to show may be based on the user's history or on co-printing coupons identified based on the top printing coupon of a user. For example a user's historical data might reveal that the most popular coupons a user has printed are {X1,X2,X3} However, the most likely co-printed coupon with {X1,X2,X3} could be {Y1,Y2,Y3}. The algorithm chooses the most optimal combination of X's & Y's to maximize the likelihood that the user would print a coupon that is recommended. This problem of finding the optimal choice can be solved through a 0-1 knapsack algorithm. The 0-1 knapsack algorithm is a dynamic programming approach solve for the optimal mix of items to that can be taken from a set to optimize a given function. The function “f” in this case is the likelihood to print. The 0-1 knapsack algorithm takes in as input item-value pairs. The items are coupons and the value is the likelihood of print of a coupon for a given user. The likelihood of prints for the co-printing coupons is directly related to the co-printing probability. The objective function “f” to optimize for a given coupon “Xi” is given as: fᵢ=max{P(Xᵢ),P(Y₍ᵢ₊₁₎|X₍ᵢ₊₁₎)×P(Y₍ᵢ₊₁₎). P(Y|X) is the co-printing probability of coupon Yi, given user has printed Xᵢ. The X's denote a user's historical prints. The Y's denote the highest top co-printing coupons corresponding to the X's. If Xᵢ is the bigger of the two, then Xᵢ is chosen, else Yᵢ₊₁ is chosen. This process has a substructure to it which can be solved using standard 0-1 knapsack algorithms. Any suitable technique may be used to solve the 0-1 knapsack algorithm.

In an embodiment, a history of the recommendations that the user actually accepts is maintained. The history may be utilized for a variety of purposes, including as input into future executions of algorithms for identifying items to recommend to the users, and for evaluating the suitability of an algorithm for a particular user state.

### 5.0. Implementation Mechanism—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

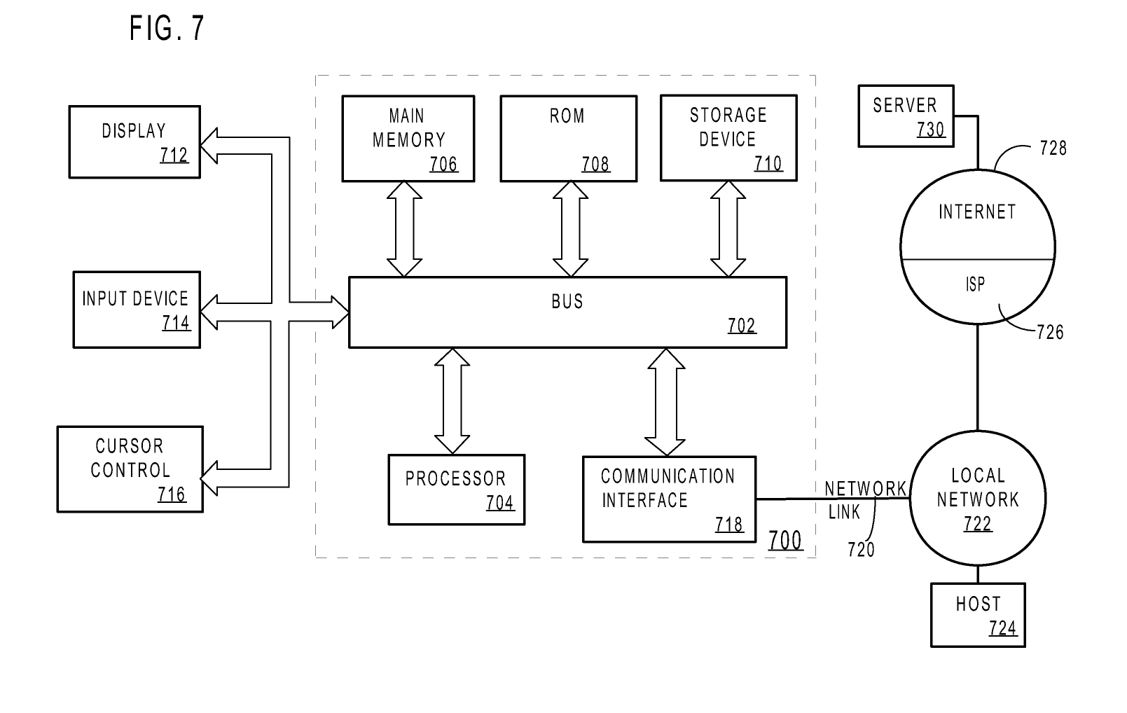

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### 6.0. Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
identifying location data associated with a client;
identifying, from a plurality of items that may be selected, any items that have been recently selected at the client, wherein the items include one or more of: products for purchase, services for purchases, or coupon offers;
detecting a user state for the client, from a plurality of different enumerated user states,
based at least on one or both of: items that have been recently selected, or the location data;
maintaining a plurality of instruction sets, each instruction set implementing a different algorithm of a plurality of algorithms configured to recommend items from the plurality of items;
based upon the detected user state, selecting a particular algorithm;
executing a particular instruction set that implements the particular algorithm;
based on executing the particular instruction set, identifying recommended items;
causing information about the recommended items to be presented at the client;
responsive to presenting the information about the recommended items, receiving input at the client for selecting one or more of the recommended items for at least one of: adding to a shopping list, or requesting a coupon;
wherein the method is performed by one or more computing devices.

2. The method of claim 1,
wherein the detected user state is a recipe mode;
wherein the particular algorithm corresponding to the recipe mode comprises selecting recommended items that occur in recipe clusters with one or more of the items that have been recently selected.

3. The method of claim 2, wherein detecting the recipe mode is based on, for each item of the items that have been recently selected, a probability that the item is used in a recipe, wherein each probability for each item is calculated based on a plurality of other input indicating a likelihood that one or more item sets that include the item were selected for use in a recipe.

4. The method of claim 2, wherein the recipe clusters are based on a plurality of other input indicating a likelihood that one or more item sets that include the item were selected for use in a recipe.

5. The method of claim 1,
wherein the detected user state is a grocery-shopping mode;
wherein the particular algorithm corresponding to the grocery-shopping mode comprises:
based on historical data for an account associated with the client, identifying first recommended items from a first set of items that have been previously selected in association with the account;
identifying second recommended items from a second set of items that frequently co-occur, with the items in the first set of items, in other sets of selected items;
merging the first set of recommended items and the second set of recommended items based on probabilities associated with each item in the first set of recommended items and the second set of recommended items.

6. The method of claim 5,
wherein identifying the second recommended items comprises: analyzing a plurality of collections of items sets for co-occurring items and assigning co-occurrence scores to the co-occurring items based on a co-occurrence frequency within each collection in which the co-occurring items occur;
wherein each of the plurality of collections consists of item sets selected exclusively by different groups.

7. The method of claim 6, further comprising selecting at least one of the groups based on the location data.

8. The method of claim 1,
wherein the detected user state is a quick shopping-run mode;
wherein the particular algorithm corresponding to the quick shopping-run mode comprises:
analyzing a user history for selection patterns indicating windows of time in which the item is expected to be selected;
identifying the recommended items based upon the selection patterns.

9. The method of claim 8, wherein a particular selection pattern of the selection patterns comprises a cycle of phases, each phase of the phases having different windows of time occurring at different frequencies relative to each other of the phases.

10. The method of claim 8, wherein detecting the quick shopping-run mode comprises detecting that more than a certain number of items were added to a shopping list within a recent period of time.

11. The method of claim 1, further comprising:
sending state data specifying the user state from a client device at which the user state is detected to server-based recommendation engine at which the particular algorithm is selected and executed;
sending recommendation data specifying the recommended items from the recommendation engine to the client device.

12. One or more non-transitory media storing instructions that, when executed by one or more computer devices, cause:
identifying location data associated with a client;
identifying, from a plurality of items that may be selected, any items that have been recently selected at the client, wherein the items include one or more of: products for purchase, services for purchases, or coupon offers;
detecting a user state for the client, from a plurality of different enumerated user states, based at least on one or both of: items that have been recently selected, or the location data;
maintaining a plurality of instruction sets, each instruction set implementing a different algorithm of a plurality of algorithms configured to recommend items from the plurality of items;
based upon the detected user state, selecting a particular algorithm;
executing a particular instruction set that implements the particular algorithm;
based on executing the particular instruction set, identifying recommended items;
causing information about the recommended items to be presented at the client;
responsive to presenting the information about the recommended items, receiving input at the client for selecting one or more of the recommended items for at least one of: adding to a shopping list, or requesting a coupon;
wherein the method is performed by one or more computing devices.

13. The one or more non-transitory media of claim 11,
wherein the detected user state is a recipe mode;
wherein the particular algorithm corresponding to the recipe mode comprises selecting recommended items that occur in recipe clusters with one or more of the items that have been recently selected.

14. The one or more non-transitory media of claim 13, wherein detecting the recipe mode is based on, for each item of the items that have been recently selected, a probability that the item is used in a recipe, wherein each probability for each item is calculated based on a plurality of other input indicating a likelihood that one or more item sets that include the item were selected for use in a recipe.

15. The one or more non-transitory media of claim 13, wherein the recipe clusters are based on a plurality of other input indicating a likelihood that one or more item sets that include the item were selected for use in a recipe.

16. The one or more non-transitory media of claim 11,
wherein the detected user state is a grocery-shopping mode;
wherein the particular algorithm corresponding to the grocery-shopping mode comprises:
based on historical data for an account associated with the client, identifying first recommended items from a first set of items that have been previously selected in association with the account;
identifying second recommended items from a second set of items that frequently co-occur, with the items in the first set of items, in other sets of selected items;
merging the first set of recommended items and the second set of recommended items based on probabilities associated with each item in the first set of recommended items and the second set of recommended items.

17. The one or more non-transitory media of claim 16,
wherein identifying the second recommended items comprises: analyzing a plurality of collections of items sets for co-occurring items and assigning co-occurrence scores to the co-occurring items based on a co-occurrence frequency within each collection in which the co-occurring items occur;
wherein each of the plurality of collections consists of item sets selected exclusively by different groups.

18. The one or more non-transitory media of claim 17, further comprising selecting at least one of the groups based on the location data.

19. The one or more non-transitory media of claim 11,
wherein the detected user state is a quick shopping-run mode;
wherein the particular algorithm corresponding to the quick shopping-run mode comprises:
analyzing a user history for selection patterns indicating windows of time in which the item is expected to be selected;
identifying the recommended items based upon the selection patterns.

20. The one or more non-transitory media of claim 19, wherein a particular selection pattern of the selection patterns comprises a cycle of phases, each phase of the phases having different windows of time occurring at different frequencies relative to each other of the phases.

21. The one or more non-transitory media of claim 20, wherein detecting the quick shopping-run mode comprises detecting that more than a certain number of items were added to a shopping list within a recent period of time.

22. The one or more non-transitory media of claim 11, further comprising:
sending state data specifying the user state from a client device at which the user state is detected to server-based recommendation engine at which the particular algorithm is selected and executed;
sending recommendation data specifying the recommended items from the recommendation engine to the client device.

23. A data processing system comprising:
a database describing a plurality of items that may be selected, the plurality of items including one or more of: products for purchase, services for purchases, or coupon offers;
a memory storing a plurality of instruction sets, each instruction set implementing a different algorithm of a plurality of algorithms for recommending items from the plurality of items;
one or more computing devices configured to implement a recommendation engine which computing devices during execution cause performing:
receiving from a client computer, over a network, input indicating a user state associated with the client computer, from a plurality of different enumerated user states;
based upon the detected user state, selecting a particular algorithm, from the plurality of algorithms, for recommending items;
executing a particular instruction set, from the plurality of instruction sets, that implements the particular algorithm;
based on executing the particular instruction set, identifying recommended items;
sending, to the client computer, recommendation data describing the recommended items.
